(19) United States
(12) Patent Application Publication
(10) Pub. No.: US 2016/0082353 A1
(43) Pub. Date: Mar. 24, 2016

(54) METHOD AND SYSTEM TO USE AN INTERRUPTION COMPONENT IN AN INTERACTIVE GAME SESSION TO ENCOURAGE GAMERS TO EXERCISE

(71) Applicant: Maurice David CHRISTOVALE, New York, NY (US)

(72) Inventor: Maurice David CHRISTOVALE, New York, NY (US)

(21) Appl. No.: 14/490,453

(22) Filed: Sep. 18, 2014

(51) Int. Cl. A63F 13/533; A63F 13/816

(52) U.S. Cl. CPC A63F 13/533; A63F 13/816

(57) ABSTRACT

Method and system for encouraging garners to indulge in a suitable physical activity during a gaming session by using a combination of psychology, engineering, biomechanics, industrial design, physiology (ergonomics) to combat the effects of a sedentary lifestyle. The Mediator component interrupts game play or television time. The user would be able to disable any joint action of their choice, allowing those with disabilities to have appropriate exercise selections/recommendations. A garner can challenge another garner in an online environment where only the victors win is recorded and stored.

### TECHNICAL FIELD

Embodiments of the disclosure relate generally to the field of interactive video game sessions. Embodiments relate more particularly to use an interruption component to disrupt the game play for a predefined period of time and encourage gamers to engage in a form of physical exercise.

### BACKGROUND

The video game sector will remain one of the above-average growth segments of the global entertainment industries through the coming years, with global games spending set to exceed music spending, according to a reputed consulting firm.

In the United States, it is expected that the size of the games market will top the ailing music sector in a few years from 2014. The key growth engines include online and wireless games, new generation consoles, as well as the rapidly increasing in-game advertising business.

The gaming audience which earlier consisted mainly of kids, teenagers, and young adults has continually expanded and has engaged female and other older audience since the games being currently developed are designed to cater to one and all. Most of the users spend a considerable amount of time playing these high end video games for hours at a stretch, while staring at a screen and using their hands to perform complex maneuvers.

The physical consequences of gaming addiction include injuries and symptoms such as carpal tunnel, migraines, sleep disturbances, backaches, eating irregularities and poor personal hygiene. Further, Video game-health related problems can induce repetitive strain injuries, skin disorders or other health issues such as muscular stiffness and extreme straining of the eyes. Video games have also been linked in some studies to aggressive behavior and violence or fearful behavior by its players in the short term. Several specific names have also been given to video-game related health problems, for example PlayStation thumb, Nintendinitis and acute Wiiitis.

Although, a substantial percentage of gamers are aware of the ills of gaming addiction, they continue to indulge in it leading to excessive gaming becoming a key factor in contributing to an unhealthy sedentary lifestyle. It is also difficult to persuade gamers to substitute gaming for physical activity altogether and therefore there remains a need for a middle way. Currently existing exergames do provide some sort of physical exercise but the benefits do not seem to be far reaching or can be rendered as insignificant. It remains the need of the hour to encourage gamers to exercise in a middle of a gaming session so that they need not be switched off from the virtual gaming world altogether.

In the light of the above discussion, there appears to be a need for a software and/or based application which interrupts a gamer during a game play session and provides him with a list of exercises to be completed in a fun and challenging manner which are especially suited to his physical ability.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of an exemplary video gaming system, according to the embodiments as disclosed herein;

FIG. 2 is a schematic illustration of the software/hardware components of the Interactive Gaming System, according to the embodiments as disclosed herein.

FIG. 3 is a flow diagram explaining the process of challenging opponents during a gaming session, according to the embodiments as disclosed herein;

FIG. 4 is a block diagram of a machine in the example form of a computer system 400 within which instructions for causing the machine to perform any one or more of the methodologies discussed herein may be executed.

### DETAILED DESCRIPTION OF THE EMBODIMENTS

The above-mentioned needs are met by a method and system for enabling a video game to use a hardware/software component to alert users of a physical activity of their choice. The following detailed description is intended to provide example implementations to one of ordinary skill in the art, and is not intended to limit the invention to the explicit disclosure, as one or ordinary skill in the art will understand that variations can be substituted that are within the scope of the invention as described.

The embodiments of the present invention generally provides various techniques for using existing videogames for physical training and/or rehabilitation. Information is gathered about movements of a person, which could be an adult or child. This information is mapped to one or more game controller commands. The game controller commands are coupled to a videogame session, and the videogame session responds to the game controller commands as it would normally.

In one aspect of the present invention, a videogame interface is a separate computer system from the computer system executing the videogame. The videogame interface accepts input from sensors attached to the person, from a video camera that captures the movements of the person, or from both.

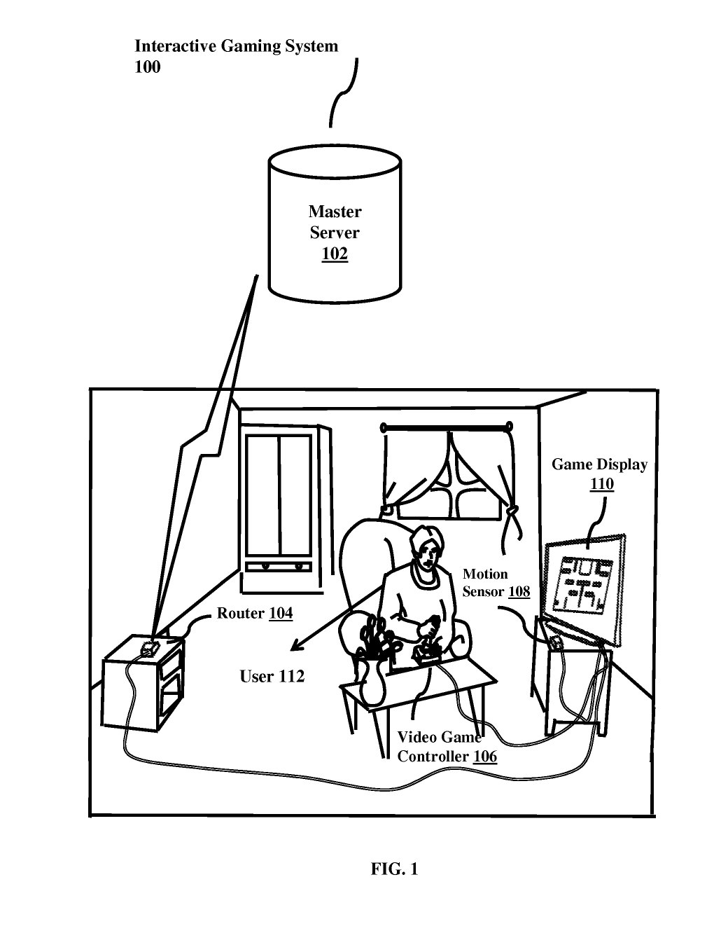

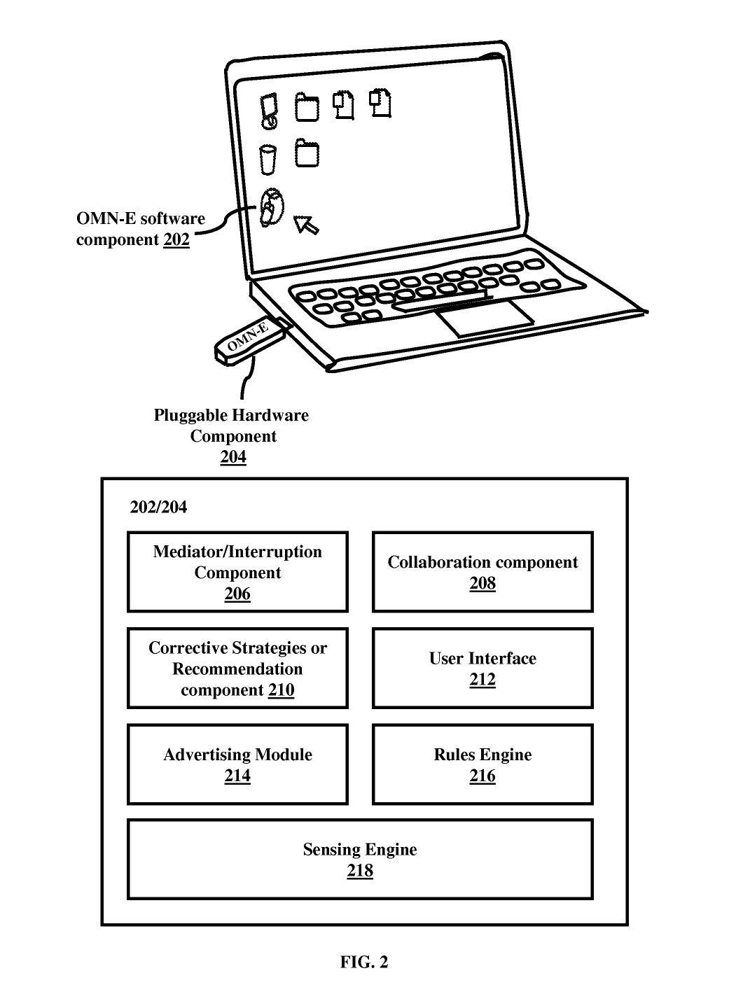

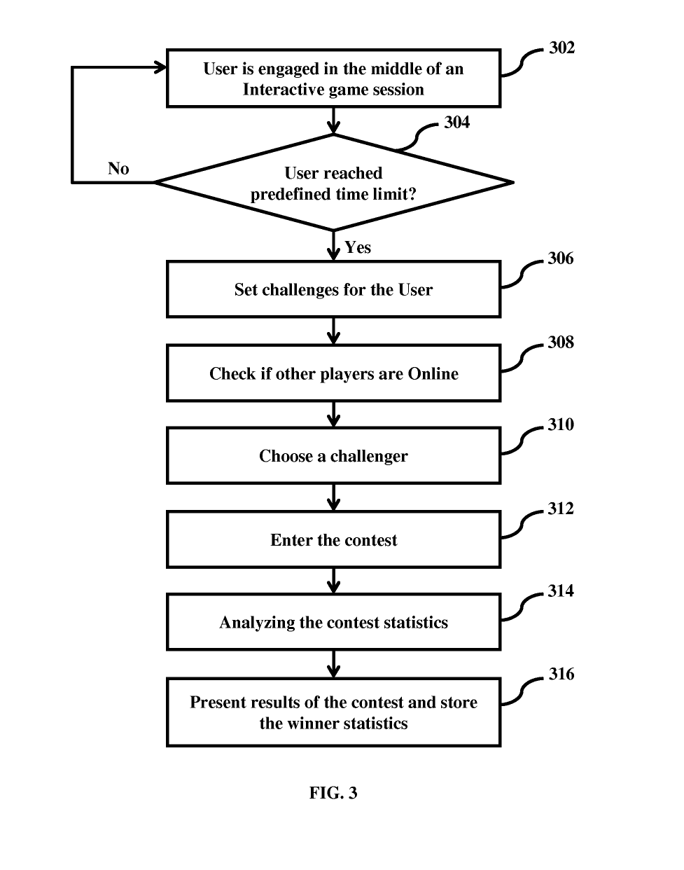

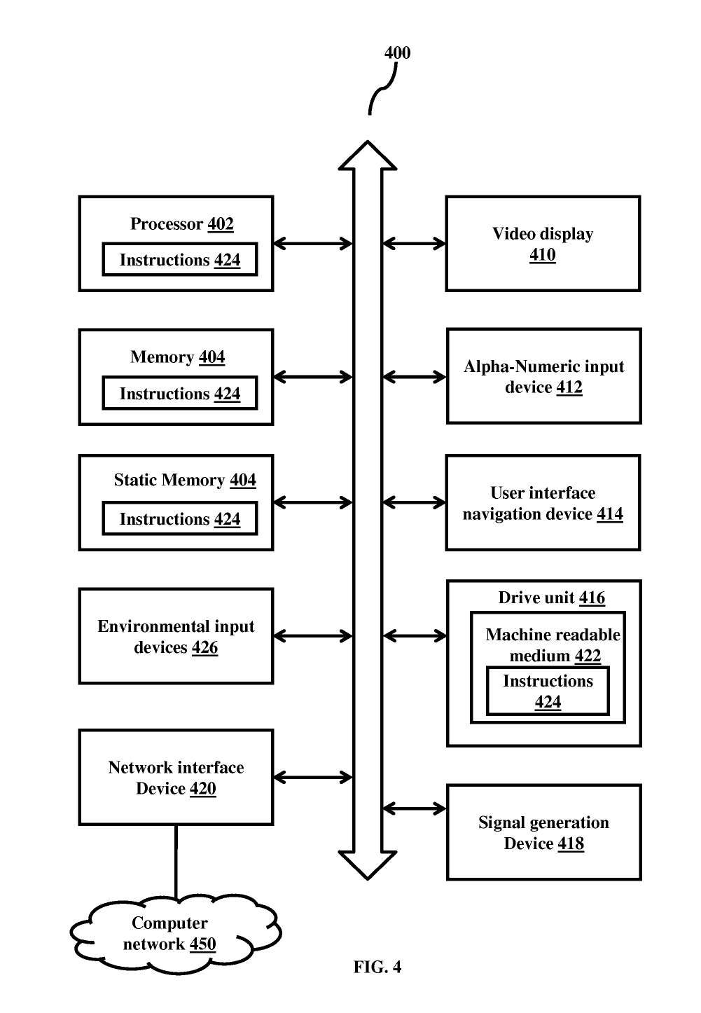

In the discussion which follows, various aspects of hardware implementations will be described, under the subheading “HARDWARE AND SYSTEM RELATED DESCRIPTION” and in connection with FIGS. 1, and 2. System hardware implementations will be discussed further, under the subheading “EXEMPLARY SYSTEM ARCHITECTURE” and in connection with FIG. 4. Also, various aspects of software and graphical user interface embodiments will be discussed under the subheadings “PROCESS DESCRIPTION OF THE CURRENT METHOD TO USE AN INTERRUPTION COMPONENT AND IN TURN ENCOURAGING THE USER TO EXERCISE,” “MOTION SENSING OF THE USER BASED ON THEIR CONDITION,” and in connection with FIGS. 3 and 4.

### Hardware and System Related Description

FIG. 1 is a block diagram of an exemplary video gaming system, according to the embodiments as disclosed herein. As depicted in FIG. 1, the Interactive Gaming System 100 comprises of a Master Server 102, a Router 104, a Motion Sensor 108, a Video Game Controller 106 and a Game Display 110.

Network link(s) involved in the Interactive Gaming system 100 may include any suitable number or arrangement of interconnected networks including both wired and wireless networks. By way of example, a wireless communication network link over which mobile devices communicate may utilize a cellular-based communication infrastructure. The communication infrastructure includes cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others. In various embodiments, network link may further include, or alternately include, a variety of communication channels and networks such as WLAN/Wi-Fi, WiMAX, Wide Area Networks (WANs), and Bluetooth.

The Interactive Gaming System 100 may be operably connected with (or included within) an enterprise network. The Enterprise network may further include one or more of email or exchange servers, enterprise application servers, internal application store servers, authentication (AAA) servers, directory servers, Virtual Private Network (VPN)/SSL gateways, firewalls, among other servers and components. Email or exchange servers may include Exchange Active Sync (EAS) or other functionality that provides synchronization of contacts, calendars, tasks, and email between Active sync enabled servers and mobile devices. Other synchronization products can also be used. The mobile devices may access or utilize one or more of these enterprise systems or associated functionality.

In certain embodiments, server and/or the mobile development service may be hosted and operated by one or more third-party service providers and/or may be accessed by developers through network using a developer computer. In certain embodiments, network may be any suitable type of wired and/or wireless network such as an Internet network or dedicated network that allows developers to access to the Interactive Gaming System 100 through developer computer.

Developers may access the Interactive Gaming System System 100 by navigating to one or more web pages using a standard web browser on developer computer, thereby obviating the need to download and/or install separate software on a developer computer. In certain other embodiments, the Interactive Gaming System System 100 may be a separate client or standalone software application that can be downloaded by developers from server and/or one or more other third-party servers, or may be provided to developers through any other suitable means (e.g., CD, physical disk, etc.) and installed on a developer computer.

In FIG. 1 it is illustrated a typical environment, like i.e. a living room of an apartment, where the videogames console is connected to a domestic TV set, and the Video Game Controller 106 is used for a car racing game, as shown in the Game Display 110. The Game Controller 106 may in certain cases comprise, in particular, a steering wheel device, preferably oriented on a horizontal plain surface and placed at the center of casing, so that a player is able to interact with the same device and at the same time to act on other commands. The wheel device permits to control the direction of a racing vehicle so that the functions of a steering wheel typical of a real car can be simulated: a clockwise rotary motion causes an increase of the car going to the right, a counter-clockwise rotary motion causes an increase of the car going to the left.

The Interactive Gaming System 100 interacts with a User 112 during a gaming session. The Router 104 extends an internet connection to other devices on the network (such as gaming consoles and PCs) and lets gamers share an intra-network connection for multi-gamer experience. For example, the User 112 may choose a Router with gigabit Ethernet ports. This router is capable of wiring a gaming console or desktop to one of the Gigabit LAN ports and takes advantage of the 1,000 Mbps speed. The Router 104 may also be configured with some form of traffic shaping or QoS (Quality of Service), wherein the network traffic can be prioritized. This feature signifies that the gaming traffic will be allocated the most bandwidth over other types of traffic on the network.

The Game Display 110 visually relays information to the User 112 as part of a game's user interface. The Game Display 110 is frequently used to simultaneously display several pieces of information including the main character's health, items, and an indication of game progression.

The Master Server 102 acts as a central database where the data pertaining to the User 112 and other game related data is stored. For example, the User 112 related data could be the profile of the user, IP address, and other similar characteristics. The Game related data can be information relating to results, scores, levels reached, update downloads, list of online gaming sessions and so on. The Master Server 102 presents a list of active sessions to players and allows them to manually select one. This system can be used in conjunction with ranking and lobbies and also allows players to filter the results they provide. The Common filter criteria include server name, player count, game mode and latency.

The Motion Sensor 108 controls the motion of some object in a game or allows players to interact with the Interactive Gaming System 100 through one or more body movements. The input is usually through a combination of spoken commands, natural real-world actions and gesture recognition. The Motion Sensor 108 uses accelerometers to detect its approximate orientation and acceleration, and serves as an image sensor. The Motion Sensor 108 is used to achieve some desired benefits which can include increased position and speed accuracy, higher speeds, faster reaction time, increased production, smoother movements, reduction in costs and so on.

FIG. 2 is a schematic illustration of the software/hardware components of the Interactive Gaming System, according to the embodiments as disclosed herein. As depicted in FIG. 2, the Interactive Gaming System 100 can be implemented as an external device similar to a memory card stick or as a software program. In case, the Interactive Gaming System 100 is built as software, it is usually licensed to including but not limited to a video game developer, marketer, publisher and or distributors and then have it embedded in a video game. For the purposes of the present subject matter, the Interactive Gaming System 100 can be enabled in an external device which can be a Pluggable (or connectable) Hardware Component 204 or an OMN-E software component 202. The Pluggable Hardware Component 204 can be any device which can be suitably connected to a gaming computer or computing device. For the purpose of illustration, the Gaming Display 110 is shown as a Television Display. It has to be known by a person of ordinary skill in the art, that the embodiments of the present subject matter can be implemented in any suitable computing device such as PDA's, tablets, smart phones and so on.

The Interactive Gaming System 100 can also be enabled by an OMN-E software component 202. OMN-E is a colloquial term used in the embodiments herein to describe the Software component 202 which is a critical part of the Interactive Gaming System 100. Usually, the software packages for making video games generally include three categories such as 3-D games, 2-D games and role playing games. The Software component 202 can also include an artificial intelligence software component to detect and predict the User′ 112 moves in a game session.

As further depicted in FIG. 2, the Pluggable Hardware Component 204 or OMN-E software component comprises of a Mediator/Interruption Component 206, a Collaboration Component, a Corrective Strategies or Recommendation Component 210, a User Interface 212, an Advertising Module 214, a Rules Engine 216, and a Sensing Engine 218.

The embodiments of the present subject matter can be used to motivate family, friends and others to become physically active by issuing challenges and requesting collaborations. The Interactive Gaming System 100 requires active participation from one or more Users 112 in order to provide a conducive outlet for movement.

The present subject matter uses a combination of psychology, engineering, biomechanics, industrial design, physiology (ergonomics) to combat the effects of a sedentary lifestyle. In an embodiment, the Interactive Gaming System 100 allows participants to perform the strength/endurance routines in a collaborative or competitive fashion using an online multiplayer gaming and digital service which encourages social interaction.

Although, it has so far been described that the embodiments herein are enabled by a Interactive Gaming System 100, it must be known to a person of ordinary skill in the art that the present subject matter is also targeted at television/laptop viewers or in general screen viewers.

In an embodiment, the Mediator/Interruption Component 206 disrupts game play after a pre-defined period of time. For example, the disruption of game play can occur after 2 hours of consecutive game play, verbal or physical expression of rage by the User 112, during a “challenge or collaboration”, seven consecutive losses in a game session or a commercial break.

The Mediator/Interruption Component 206 also allows the User 112 to disable any joint action of their choice, allowing those with disabilities or problems to choose appropriate exercise selections or recommendations.

The Collaboration Component 208 allows one or more Users 112 to connect and collaborate during a gameplay session. The Users 112 could interact during a multiplayer online session or can be invited to connect and interact by at least one User 112. The Collaboration Component 208 is configured to connect Users 112 with each other for the purpose of competing in physical or educational challenges. For example, Player A gets agitated and frustrated within his gaming experience and therefore Player A may request the Mediator/Interruption Component 206 to disrupt the game for a while by clicking on the option (in case of Software Component 202) or switching/activating the button (in case of Pluggable Hardware Component 204).

The Collaboration Component 208 pauses the game which the User 112 (Player A) is playing, in order to reach out to a host of individuals that have an option called “accept challenges” enabled in the preference settings of the game. Once, Player B has accepted Player A's challenge of (say) 40 pushups, the Users 112 go on to compete with each other. The Collaboration Component 208 utilizes the built in Motion Detectors 108 to monitor the actions of the Users 112.

In a preferred embodiment, once a particular challenge is completed only the victors win is recorded and stored in the Master Server 102. The losses are not recorded or stored in order in order to encourage people to be active. For instance, Player A may chose to collaborate with Player B and the Collaboration Component 208 may roll out a task such as a 20 sec Brain Game or tongue twister. The collaborated efforts of all participants determine the rank or score. Once challenges are completed and players return to the game session, the User 112 would be able to disable any joint action of their choice allowing those with disabilities to have appropriate selections/recommendations.

The Corrective Strategies or Recommendation component 210 offers a wide variety and approaches to corrective strategies after knowing the results of the User 112. For example a 2 minute Tai chi session allows the User 112 to draw his attention to the Macrocosm. A few techniques are demonstrated for the benefits of this particular exercise. A short tai chi session focuses on the breath and fluent harmonious movement of the body. Incremental improvement deals with yoga poses that alleviate tension from the spine, chest, and shoulders of the body which may also be performed for a total of 2 minutes. These corrective strategies are usually different for each user. For example, if the User 112 is a 40 year old sedentary man then the Recommendation component 210 may suggest for few minutes of stretching and deep meditation.

In an embodiment, the Primary purpose of the Mediator/Interruption component 206 is to be the mediator between entertainment and motion. The increase in physical activity combats the negative effects of a posture acquired by playing video games or watching the screen for a prolonged period of time. The Mediator/Interruption component 206 enforces mandatory active breaks which require the users to perform strength or endurance routines or mobility/flexibility techniques depending on the circumstance.

### Process Description of the Current Method to Use an Interruption Component and in Turn Encouraging the User to Exercise

FIG. 3 is a flow diagram describing the process undergone by the Mediator component, according to the embodiments as disclosed herein. As depicted in FIG. 3, at Step 302, the User 112 is engaged in the middle of an interactive game session. For example, the User 112 may be playing Grand Theft Auto (San Andreas) on his xbox console for a more than an hour continuously. The Mediator Component 206 checks if the User has reached a predefined time limit in order to disrupt the game session at Step 304. In case, the User 112 has not reached the predefined time limit, then the User 112 can go back to resume the game session. If the User 112 has reached the predefined time limit then the Mediator Component 206 can disrupt the game session and set challenges for the User at Step 306.

In an embodiment, the Mediator Component 206 disrupts game session, television, computer usage or any form of screen viewing after one of the below mentioned five events take place. Two hours of game play requires mandatory active participation in physical activity by the User 112. A guardian like character or symbol appears to visually guide the User 112 through a 60 second mobility technique. At the 4 hour mark, the guardian guides the gamer through a two minute flexibility sequence. Once the User 112 stops moving, the 20 second timer stops and when every repetition of the appointed exercise is completed, The Mediator Component 206 allows the User 112 to resume his game session.

In another embodiment, the User 112 is provided with an option to disable any joint action of their choice allowing those with disabilities to undergo appropriate exercise selections/recommendations. For example, for individuals that are bound to a wheelchair or are physically challenged in some way, the Mediator Component 206 uses a feature that allows the user to disable ankle, knee, hip exercises and more which would have been ordinarily issued to the User 112.

In another use case, involving verbal or physical expression of rage (mandatory active participation), the term “Rage” interrupts the video game if the user uses vulgar language or physically expresses rage. Physical expression of the rage would include throwing the controller, wailing of the arms, and jumping out of the seat in a sudden manner. In this case, the User 112 is made to do a (20 second) strength or endurance circuit exercise. Once the User 112 stops moving the timer stops and when every repetition of the appointed exercise is completed, the Mediator Component 206 resumes the game session for the User 112. The underlying idea behind the “Rage” form of expression is that if the User 112 has enough energy to express anger then that anger or energy can be expressed consecutively. By implementing “Rage”, the User 112 can learn to control his temper and go through a physically active video game experience.

In order to go through a challenge or collaboration mode, the User 112 needs to check if other players are online at Step 308 and then choose a challenger for contest at Step 310. By utilizing online multiplayer gaming and digital media delivery services and entering the contest at Step 312, the Collaboration Component 208 connects gamers with each other for the purpose of competing in physical or educational challenges at Step 312. For example, the Mediator Component 206 may suggest that the User 112 complete 10 chin ups once the user has the “accept challenge mode” activated in the preferences. Once the challenge is accepted by another gamer, the Motion Detector 108 utilizes the game consoles to keep a check on the movements of the gamers. The collaborated efforts of both participants determines rank or score by analyzing the contest statistics at Step 314. After challenges are completed players are returned to their game session by the Mediator component 206. The results of the contest and the winner's statistics are presented on the Game Display 110 and the statistics of the winner are stored in the Master Server 102.

In another example use cases, after a period of seven consecutive losses that produce anger and stress on the User 112, the Game Display 110 goes black/blank and the words “Envision your challenge” appears. A 20 second motivational tune plays while the gamer performs a series of Jab/Cross combinations before being returned back to the game. A commercial break can also be offered as a disruption by the Mediator Component 206 to offer a wide variety and approaches to a number of corrective strategies. The Corrective Strategies or Recommendation component 210 uses psychology, engineering, biomechanics, industrial design and physiology to combat the effects of a sedentary lifestyle. One or more corrective exercises cover the biomechanic aspect and specific exercises would be recommended to counteract other sedentary postures.

In an embodiment, the Corrective Strategies or Recommendation component 210 utilizes the principles of physiology to engage the kinetic chain and by incorporating the active stimulus into a period of sedentary entertainment will produce positive change on a cellular level over time. This physical activity requires that blood moves rapidly to and from organs and through contracted muscles distributes essential nutrients and oxygen throughout the body.

While using the psychology aspect, the Corrective Strategies or Recommendation component 210 substitutes commercials during children's programs with some sort of physical activity. In an embodiment, all game consoles in the Interactive Gaming System 100 provide an online platform for multiplayer gaming and social interaction. Each player receives a gamertag (online persona) and in one case player Ws gamertag is Lovelife 247. Lovelife 247 appears on Player A's online friends list when one signs in and Player A thinks that it would be nice to welcome Lovelife 247 with a challenge. Player A requests the Mediator Component 206 to submit a burpee challenge to his friend to see who can do the most burpees in 1 minute. In an embodiment, the challenger accepts the invitation and the Mediator Component 206 projects the exact image on the screen or an avatar can be used for the sake of privacy.

The Mediator Component 206 counts and records each repetition and at the end of the challenge Player A performed 20 repetitions and the Player Lovelife finishes with 24 counts and receives the credit for winning the challenge at no cost or penalty to the player. Although Player A does not receive a victory, 20 repetitions of Burpees and 1 minute spent exercising will be added to the statistics. The total amount of repetitions per exercise, victories and accumulated time spent exercising is tallied and saved for the victor. It also has to be noted that during online usage each User 112 has the ability to invite one or more friends and play a particular game, if they both have the game. Further, the reason why only winner statistics are stored is because research shows that the fear of losing produces anxiety and stress. This fear can also act as an deterrent which may be counterproductive to the ultimate objective of weaning oneself from a sedentary lifestyle.

Motion Sensing of the User Based on their Condition

Information about the movements is collected front the Motion Sensor 108 or from Game Display 110 or from both of these. The joystick or keyboard commands are sent over connection to videogame program, which interprets the commands and acts on them. In the example of FIG. 1, the connection is a device suitable for communicating both joystick and keyboard commands to computer system. For instance, the connection could be a Universal Serial Bus (USB) cable or Firewire (also known by the Institute of Electronic and Electrical Engineers Standard 1394). Optionally, separate cables for each of the joystick and keyboard can be provided.

Based on movement information from sensors on the Motion Sensor 110 or on from video on camera, the User Interface 212 will create appropriate commands.

Alternative exemplary implementations further provide advantages over the prior art with exercise systems that enables one or more users to receive real-time signals from one or more trainers via a network; exercise systems that enable a third party to control one or more user exercise devices and one or more trainer exercise devices in real-time; exercise systems that enable a user to access various exercise equipment and information from a variety of locations; systems where one device is capable of controlling one or more operating parameters of one or more other devices; and systems where the various modules of the system may be incorporated within a variety of devices.

Various transmission or communication protocols may be used to enable the Interactive Gaming System 100 to receive and transmit data through a network. In one embodiment of the present subject matter, a computer, and more specifically, a network interface or a serial port interface, may use TCP/IP communication protocol. Alternatively, the computer may use connection orientated or connectionless networks via asynchronous transfer mode (ATM) technology, X.25 protocol, Frame Relay protocol, packet switching protocols, circuit switching protocols, dynamic packet switching protocols, 802.11RF protocol, home network protocols, CSAFE 1, CAN protocols, and the like to transmit and receive data through network.

In an embodiment, Synchronization of the Interactive Gaming System 100 prepares the communication links between each competitor and generates the Game Display 110 and data flow there between, such as, but not limited to the audio and video data flows and displays that enable each competitor to view their progress against each other. For example, the Game Display 110 may include a racing track that shows a relative position of each competitor one with another, or a trail that each competitor races along. It may be appreciated that various other data flows and displays are appropriate and known to one skilled in the art in view of the teaching contained herein.

In an aspect, the user may select a time-adjusted race. The time-adjusted race allows two or more competitors to conveniently race against each other. For example, the time-adjusted race in the Interactive Gaming System 100 allows an individual on the east coast to race against individuals in the Mountain Time zone and the west coast at the same local time, for example 5:00 p.m. The time-adjusted race, therefore, stores the race of one individual, say the individual on the east coast who races at 5:00 p.m. and then rebroadcasts the stored exercise race to those other individual various other time zones upon reaching the designated time period, such as 5:00 p.m. Mountain Standard Time, pacific time, and the like.

In particular embodiments, communication interface includes hardware, software, or both providing one or more interfaces for communication (such as, for example, packet-based communication) between computer system and one or more other computer systems or one or more networks. As an example and not by way of limitation, communication interface may include a network interface controller (NIC) for communicating with an Ethernet or other wire-based network or a wireless NIC (WNIC) for communicating with a wireless network, such as a WI-FI network. This disclosure contemplates any suitable network and any suitable communication interface for it. As an example and not by way of limitation, the full handheld computer/host 100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the system 100 may communicate with a wireless PAN (WPAN) (e.g., a Bluetooth WPAN), a WI-FI network (e.g., a 802.11a/b/g/n WI-FI network), a WI-MAX network, a cellular telephone network (e.g., a Global System for “mobile” Communications (GSM) network, a Long Term Evolution (LTE) network), or other suitable wireless network or a combination of two or more of these.

In particular embodiments, bus includes hardware, software, or both coupling components of System 100 to each other. As an example and not by way of limitation, bus may include an Accelerated Graphics Port (AGP) or other graphics bus, an Enhanced Industry Standard Architecture (EISA) bus, a front-side bus (FSB), a HYPERTRANSPORT (HT) interconnect, an INFINIBAND interconnect, a low-pin-count (LPC) bus, a memory bus, a Peripheral Component Interconnect Express or PCI-Express bus, a serial advanced technology attachment (SATA) bus, an Inter-Integrated Circuit (I2C) bus, a Secure Digital (SD) memory interface, a Secure Digital Input Output (SDIO) interface, a Universal Serial Bus (USB) bus, a General Purpose Input/Output (GPIO) bus, or another suitable bus or a combination of two or more of these. Bus may include one or more buses, where appropriate.

### Exemplary System Architecture

FIG. 5 is a block diagram of a machine in the example form of a computer system 500 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU), or both), a main memory 504, and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a user interface (UI) navigation device 514 (e.g., a mouse), a disk drive unit 516, a signal generation device 518 (e.g., a speaker), and a network interface device 520. The computer system 500 may also include a environmental input device 526 that may provide a number of inputs describing the environment in which the computer system 500 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

### Machine-Readable Medium

The disk drive unit 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504 and/or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, and/or associated caches and servers) that store the one or more instructions 524 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Transmission Medium

The instructions 524 may further be transmitted or received over a computer network 550 using a transmission medium. The instructions 524 may be transmitted using the network interface device 520 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 802.11 including its substandards a, b, e, g, h, i, n, et al.). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Accordingly, the disclosure of the present invention is intended to be illustrative, but not limiting, of the scope of the invention, which is set forth in the following claims.

What is claimed is:

1. A method of inducing individuals to engage in physical activity by interrupting the individuals while playing a video game or watching a program on a screen, the method comprising:
installing a interruption and mediator component in at least one of the video game and the screen;
setting one or more desired features in a menu screen of the video game;
interrupting at least one of a game play session and a screen session at one or more pre-defined intervals;
recording at least one movement made by the individual during an exercise session set by the mediator component; and
storing the results after the exercise session and reminding the individual to exercise again after a certain event.

2. The method as claimed in claim 1, wherein said method uses at least one of psychology, engineering, biomechanics, industrial design and ergonomics.

3. The method as claimed in claim 1, wherein said method is performed in at least one of a collaborative and competitive fashion using an online multiplayer gaming and digital service to encourage social interaction.

4. The method as claimed in claim 1, wherein said method is configured to disable a joint action of a user's choice to allow the user choose at least one of appropriate exercise selections or recommendations.

5. The method as claimed in claim 1, wherein said method allows a plurality of said users to connect and interact during a multiplayer online session.

6. The method as claimed in claim 1, wherein said method is configured to sense motion of the users.

7. The method as claimed in claim 1, wherein said method allows one or more said individuals to challenge during a multiplayer session.

8. The method as claimed in claim 1, wherein collaborated efforts of said individuals determine at least one of a rank or a score.

9. The method as claimed in claim 1, wherein said method stores results of a winner of a challenge.

10. The method as claimed in claim 1, wherein said method recommends at least one corrective strategy based on an outcome of a challenge.

11. A system for inducing a plurality of individuals to engage in physical activity by interrupting the individuals while playing a video game or watching a program on a screen, the system comprising:
a mediator or interruption component configured to disrupt a game play session after a pre-defined period of time;
a collaboration component configured to connect and collaborate with said individuals during the game play session;
a master server configured to store data related to the game play session of the individuals and store results of a winner of the game play session; and
a corrective strategies or recommendation component configured to offer a wide variety of at least one corrective strategies after knowing the results of the game play session of the individuals.

12. The system as claimed in claim 1, wherein said system is configured to use at least one of psychology, engineering, biomechanics, industrial design and ergonomics.

13. The system as claimed in claim 1, wherein said system is configured to perform in at least one of a collaborative and competitive fashion using an online multiplayer gaming and digital service to encourage social interaction.

14. The system as claimed in claim 1, wherein said system is configured to disable a joint action of the individual's choice to allow the user choose at least one of appropriate exercise selections or recommendations.

15. The system as claimed in claim 1, wherein said system is configured to allow a plurality of said individuals to connect and interact during a multiplayer online session.

16. The system as claimed in claim 1, wherein said system is configured to sense motion of the individuals.

17. The system as claimed in claim 1, wherein said system is configured to evaluate collaborated efforts of said individuals to determine at least one of a rank or a score.

18. The system as claimed in claim 1, wherein said system is configured to count and record a repetition at the end of a challenge.

19. The system as claimed in claim 1, wherein said system is configured to recommend at least one corrective strategy based on an outcome of a challenge.

20. The system as claimed in claim 1, wherein said system is configured to allow one or more said individuals to challenge during a multiplayer session.
